(19) United States
(12) Patent Application Publication
(10) Pub. No.: US 2024/0089097 A1
(43) Pub. Date: Mar. 14, 2024

(54) KEY UPDATE MANAGEMENT SYSTEM AND KEY UPDATE MANAGEMENT METHOD

(71) Applicant: RENESAS ELECTRONICS CORPORATION, Tokyo (JP)

(72) Inventors: Takahiko SUGAHARA, Tokyo (JP); Yuichi IWAYA, Tokyo (JP); Akira HAMAGUCHI, Tokyo (JP)

(21) Appl. No.: 17/941,515

(22) Filed: Sep. 9, 2022

(51) Int. Cl. H04L 9/08; H04L 9/14; H04L 9/32

(52) U.S. Cl. CPC H04L 9/0891; H04L 9/0894; H04L 9/14; H04L 9/3226

(57) ABSTRACT

When the external storage itself is replaced by a legitimate old key by a malicious third party, the security IP cannot recognize that it is the old key and can be easily rolled back, that is, the old key is regarded as the legitimate key and operates. An OTP is provided in the SoC, and the version of the key ring is managed in one control table area. Specifically, predetermined information that is updated in synchronization with the key update is written in the management table area of the OTP, and an authentication value is calculated by associating the predetermined information with a key ring including the update key. The calculated authentication value is added and registered when registering the key ring.

### BACKGROUND

Recently, in the field of the electronic control unit (ECU) which is an exemplary of the semiconductor device, the robustness of the on-board network is required. In CAN (Controller Area Network), which are commonly used as in-vehicle networks, R&D on security technologies related to certification and assurance of data confidentiality is becoming active.

For example, a method of adding a message authentication code algorithm CMAC (Cipher-based Message Authentication Code), which is a block cipher-based message authentication code algorithm, to a packet of a CAN, an authentication mechanism of an ECU, and the like. In order to realize this security, it is most important to set up and manage secure cryptographic keys, and if cryptographic keys are compromised, security itself will not be established.

Therefore, a mechanism called SHE (Secure Hardware Extension), which is jointly developed by automotive manufacturers for secure setting and management of cryptographic keys, has been standardized. The key registration in the SHE standard is described below.

### (Configuration of SHE Key)

In SHE, multiple types of keys can be used. SHE keys include MASTER_ECU_KEY (MEK), BOOT_MAC_KEY (BMK), BOOT_MAC (BM), KEY_n, and RAM_KEY (RMK). The SHE key is described below.

(1) MEK

MEK is the key used to update MEK, BMK, BM, and KEY_n. MEK cannot be used for encryption and decryption processing and MAC generation and verification processing. There is a limit on the number of rewrites of MEK.

(2) BMK

BMK is the keys used to calculate CMAC in secure boot. It can be used to update BMK and BM. BMK cannot be used for encryption and decryption processing and MAC generation and verification processing. The number of BMK rewriting is limited.

(3) BM

BM is the expected value of CMAC in secure boot. It cannot be used for encryption processing and decryption processing and MAC generation processing and verification processing. The number of BM rewriting is limited.

(4) KEY_n (where N is an Integer from 1 to 10)

As Key-n, there are 10 keys from KEY_1 to KEY_10. Each KEY_n can be used in either mode 0, which can be used for encryption and decryption processing, or mode 1, which can be used for MAC generation and verification processing. Each KEY_n can be used to update its own key only. For example, KEY_1 can be used to update KEY_1. The number of each KEY n rewriting is limited.

(5) RMK

RMK can be registered in plain text by command. By commands, it can be registered by using values M1, M2, and M3. However, when registering RMK, the counter value is not included in the value M2 to be described later. Therefore, there is a vulnerability to replay attacks. KEY_n can be used to update RMK. The number of rewriting RMK is not limited.

### (Command for SHE Key Update)

(1) Command (CMD_LOAD_KEY)

The commands (CMD_LOAD_KEY) can be used to update the MEK, BMK, BM, KEY n, and RMK in FIG. 1. By the command (CMD LOAD_KEY), M1, M2 and M3 in FIG. 3 are generated and the key is updated.

(2) Command (CMD_LOAD_PLAIN_KEY)

RMKs can be registered in clear text by using the command (CMD_LOAD_PLAIN_KEY). The only key that can be registered in plain text by the command (CMD_LOAD_PLAIN_KEY) is RMK.

### (Key Update Method)

FIG. 1 is a key registration system configuration diagram in the SHE standard. FIG. 2 is a key registration flow diagram in the SHE standard. FIG. 3 is a diagram showing a key setting form in the SHE standard.

First of all, M1, M2 and M3 for registration are calculated in the key setting device 2 (step S201). The format of M1, M2 and M3 is as shown in FIG. 3. The registration data M1 specifies the key to be updated and the key responsible for the encryption/decryption process to ensure the robustness of the key. More specifically, it consists of a UID that is an ID (device-specific ID) of the SHE to be registered, an ID of the KEY_n (key that can be used for any function) to be updated/registered, and a Auth-ID that is an ID (key itself (KEY_n) to be updated/registered) or a master ECU key (MEK) to be used for key updating/registering. The registration data M2 is encrypted by merging the counter value used as a rollback measure and the key to be updated. More specifically, it consists of counters, KEY_FLAGs, and KEYID (key values to be registered). The registration data M3 is a CMAC value calculated from M1 and M2. The calculated registration data M1, M2 and M3 are transmitted to SoC 1 (step S202). A rollback measure is a security function that cannot be updated if the value is not larger than the current counter value when the key is updated, and it can be prevented even if an attempt is made to re-register the old key illegally.

The host CPU11 in SoC 1 transmits the registration data M1, M2 and M3 received from the key setting device 2 to the SHE-compliant security IP 12 (step S203). Updating the key in the security IP 12 (step S204) and registering the key in the external storage 3 (step S205). Verification data M4 and M5 are calculated (step S206). The M4 is encrypted with the counter value and the key that is responsible for the encryption/decryption process. The M5 is CMAC value of M4.

Verification data M4 and M5 calculated by the security IP 12 are transmitted to the key setting device 2 through the host CPU 11 (step S207). The key setting device 2 verifies the verification data M4 and M5 received from SoC 1 (step S208).

This series of processes enables the key setting device 2 to be safely updated and registered because the key is not handled as plaintext at the host CPU 11 between SoC 1 and SoC 1, and because the key is also provided as a rollback measure.

### SUMMARY

However, when the external storage itself is replaced by a legitimate old key by a malicious third party, the security IP cannot recognize that it is the old key and can be easily rolled back (the old key is regarded as the legitimate key and operates). If the old key was concerned about the serious danger, it would directly lead to the danger of the on-board network security, which could lead to a serious situation.

### Means of Solving the Problems

According to one embodiment, an OTP (One Time Programmable ROM) is provided in the SoC, and the version of the key bundle (a plurality of keys) is managed in one management table area. Specifically, predetermined information (e.g., a counter value) that is updated in synchronization with the key update is transmitted.

(1) The authentication value (e.g., a hash value or a MAC value) is calculated by writing to the OTP management table area and linking the key ring including the predetermined information and the update key. The calculated authentication value is added and registered when registering the key ring.

(2) Write to the OTP management table area, update the encryption key that encrypts the update key based on the predetermined information, and encrypt and register the key ring including the update key with the updated encryption key.

(3) Write to the control table area of the FW version in the existing OTP, link the FW version with the key version, and execute the centralized management of the version.

### Effect of the Invention

According to the aforementioned embodiment,
(1) Rollback can be detected even if the external storage itself is replaced with the legitimate old key.
(2) Cost reduction of OTP area can be achieved by version management of a set of keys using a single management table.

### BRIEF DESCRIPTION OF THE DRAWINGS

FIG. 1 is a key registration system configuration diagram in the SHE standard.

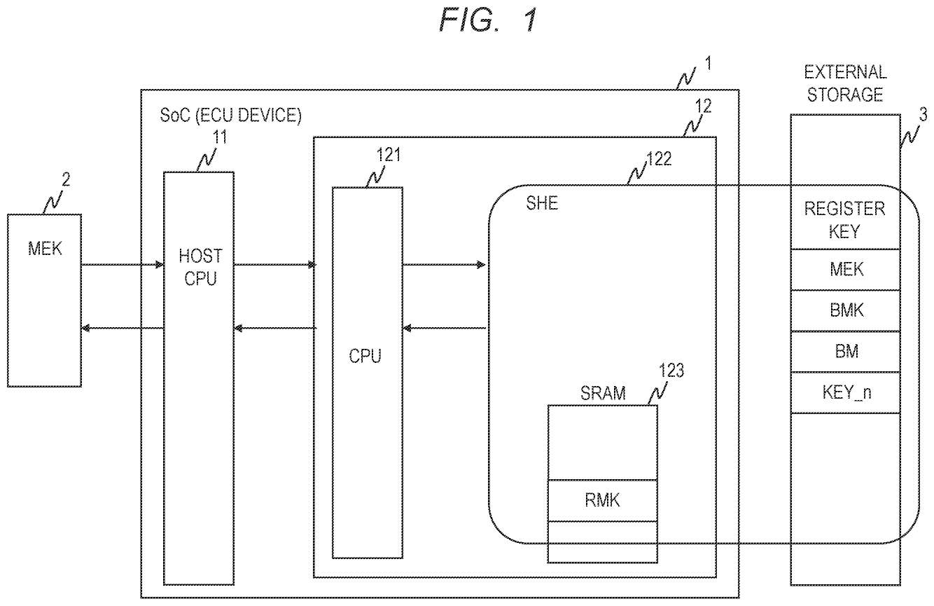

FIG. 2 is a key registration flow diagram in the SHE standard.

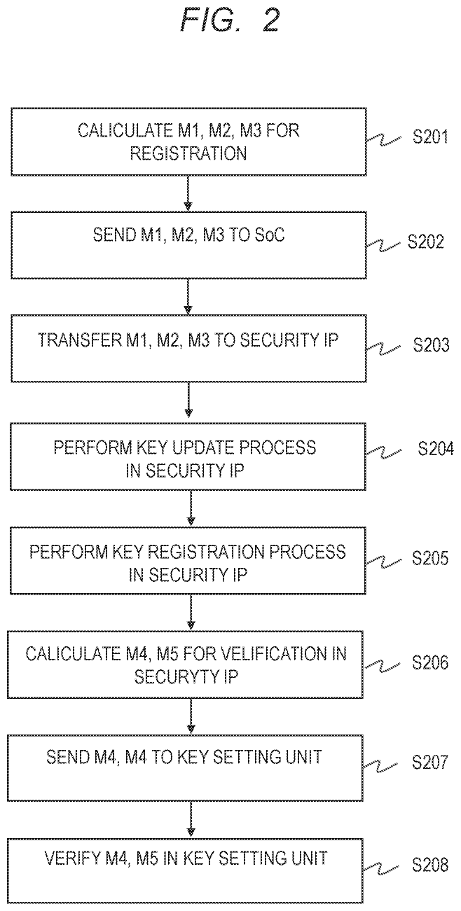

FIG. 3 is a diagram showing a key setting form in the SHE standard.

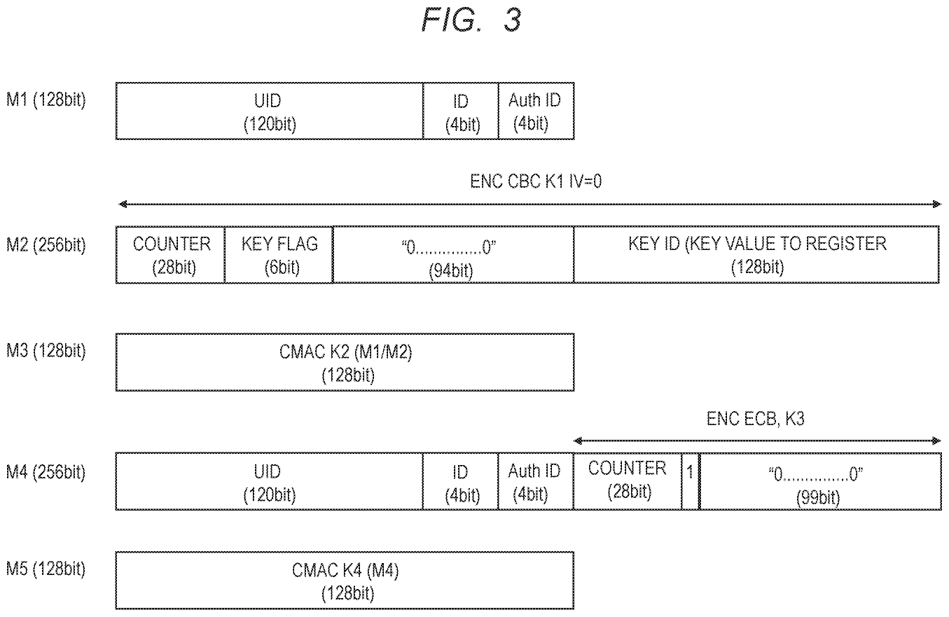

FIG. 4 is a key update management system configuration diagram according to the first embodiment.

FIG. 5 is a key update flow diagram according to the first embodiment.

FIG. 6 is a key update management system configuration diagram according to a second embodiment.

FIG. 7 is a key update flow diagram according to the second embodiment.

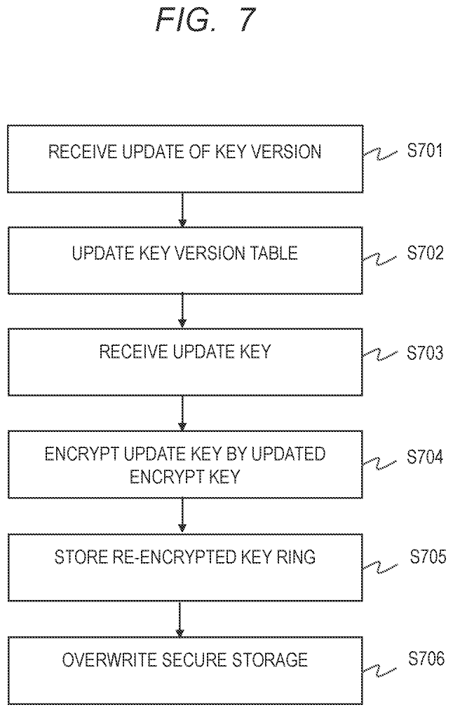

FIG. 8 is a key update management system configuration diagram according to a third embodiment.

FIG. 9 is a key update flow diagram according to the third embodiment.

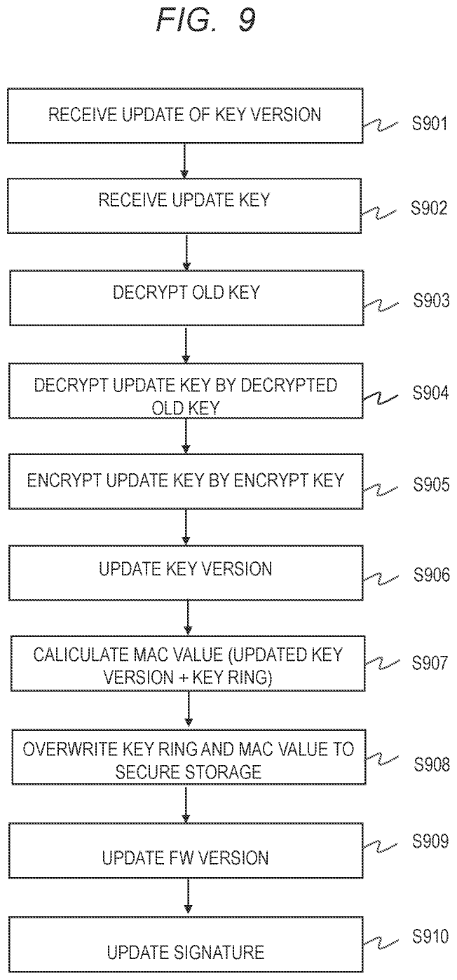

FIG. 10 is a diagram for explaining a rollback verification method of a key according to the third embodiment.

### DETAILED DESCRIPTION

Hereinafter, a data processing device according to an embodiment will be described in detail by referring to the drawings. In the specification and the drawings, the same or corresponding form elements are denoted by the same reference numerals, and a repetitive description thereof is omitted. In the drawings, for convenience of description, the configuration may be omitted or simplified. Also, at least some of the embodiments may be arbitrarily combined with each other.

### First Embodiment

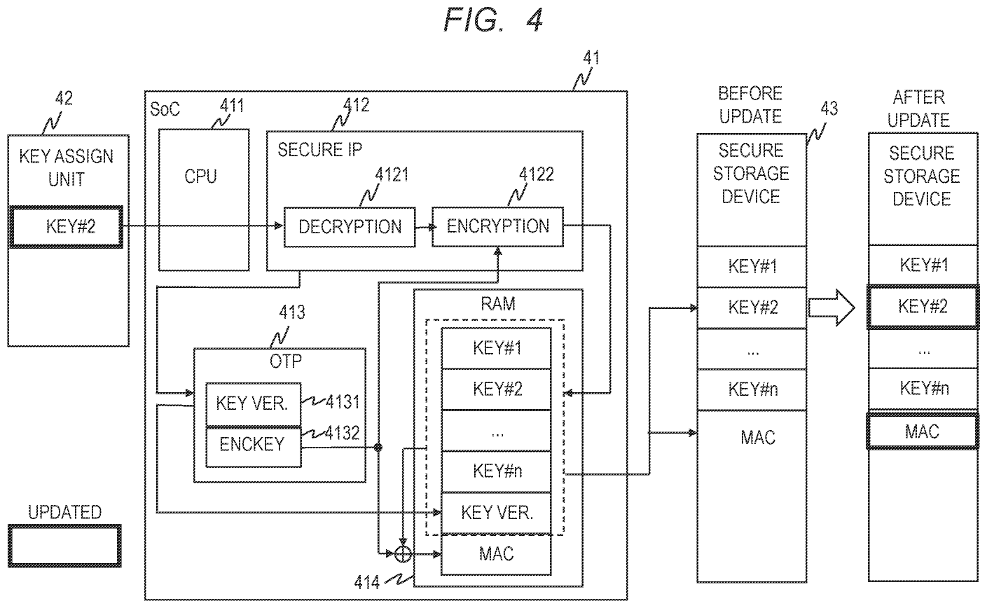

FIG. 4 is a key update management system configuration diagram according to the first embodiment. The key update management system includes a SoC 41, a key setting unit 42, and a secure storage unit 43. The SoC 41 includes a CPU 411, a secure IP 412, an OTP unit 413, and a RAM 414. The secure IP 412 includes a decryption unit 4121 and an encryption unit 4122. The OTP unit 413 stores a key version 4131 and an encryption key 4132. The secure storage unit 43 stores the MAC values of the key ring (KEY #1 to KEY #n) and the key ring (KEY #1 to KEY #n).

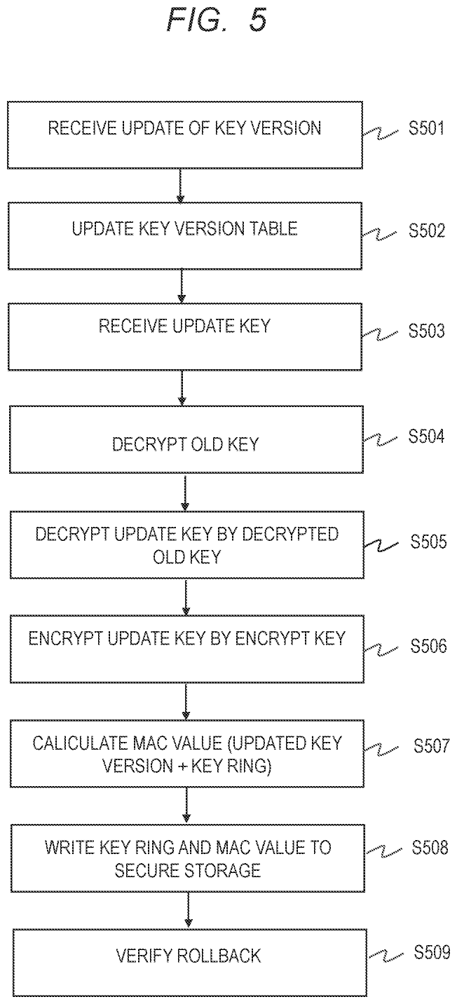

The processing in the case of updating the key KEY #2 among the key rings will be described with reference to FIGS. 4 and 5. In order to update the key KEY #2, the key setting unit 42 first requests SoC 41 to update the key version. When SoC 41 receives the update request, it transmits the key version to the secure IP 412 through CPU 411 (step S501). When the secure IP 412 receives the request for updating the key version, it updates the key version 4131 stored in the OTP unit 413 (step S502). The key version 4131 may be updated using, for example, a method of appending “1” to a table (“00000001” before updating, “00000011” after updating), or may be another method.

The update key KEY #2 is previously encrypted with the old key OKEY #2, the key setting unit 42 transmits the update key KEY #2 to SoC 41, and when SoC 41 receives the update key KEY #2, it transmits it to the secure IP 412 through CPU 411 (step S503). When the secure IP 412 receives the update key KEY #2, the decryption unit 4121 decrypts the recovery key OKEY #2 (step S504), decrypts the update key KEY #2 with the decrypted recovery key OKEY #2 (step S505), and the decrypted update key KEY #2 is encrypted by the encryption key 4132 stored in the OTP unit 413 in the encryption unit 4122 and stored in RAM 414 (step S506).

Next, for the rollback verification, the secure IP 412 calculates the key version 4131 updated in the step S502 and the MAC value of the key ring by the encryption key 4132 stored in the OTP unit 413 that encrypts the update key KEY #2 decrypted in the step S505 in the step S506, and stores the calculated key version in RAM 414 (step S507). Further, the MAC value calculated by the key ring and the step S505 is stored by overwriting the secure storage unit 43 (step S508). The encryption key used for calculating the MAC value may separately store the dedicated encryption key in the OTP unit 413. Also, the method of storing in the secure storage unit 43 is not limited to overwriting, and may be stored in another area where existing values are stored.

The rollback verification is performed at system startup, and the secure IP 412 is performed by calculating the MAC value from the key ring stored in the secure storage 43 and the key version 4131 stored in the OTP unit 413 and comparing the calculated MAC value with the MAC value stored in the secure storage 43 (step S509). As a result of the comparison, the process continues if it matches, and if there is a mismatch, a failure occurs in which the key stored in the secure storage unit 43 is replaced, so that security measures are required. Note that key updating may be performed on a set of key rings (KEY #1 to KEY #n) as well as individual keys of the key ring.

According to the first embodiment, the rollback can be detected even if the external storage itself is replaced with a legitimate old key. In addition, since the key ring is version-managed by one table, the cost reduction of OTP can be attempted.

### Second Embodiment

In the first embodiment, a method of updating one key has been described, but in a second embodiment, a method of updating a set of key rings will be described.

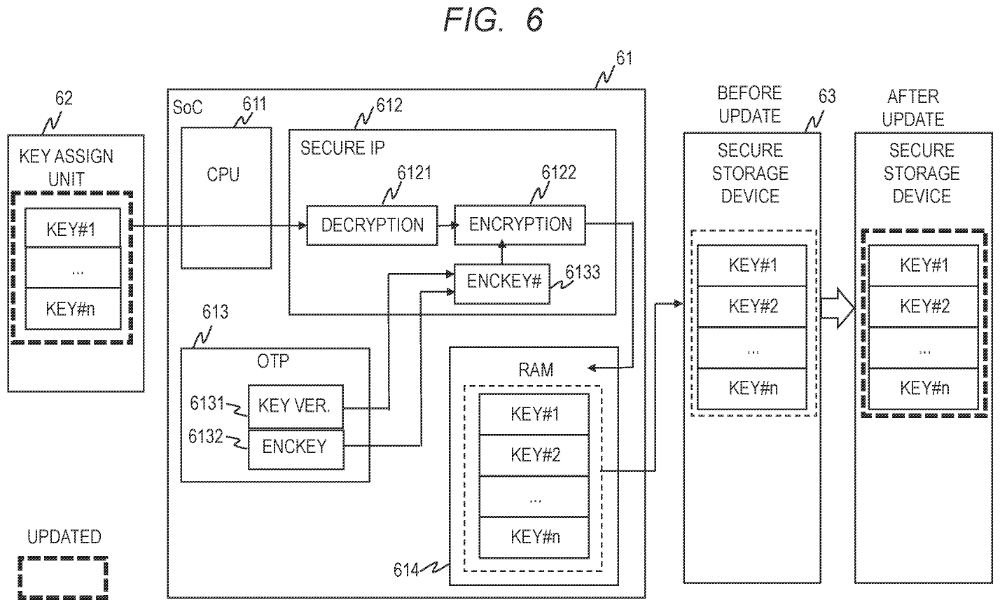

FIG. 6 is a key update management system configuration diagram according to a second embodiment. The key update management system includes a SoC 61, a key setting unit 62, and a secure storage unit 63. SoC 61 includes a CPU 611, a secure IP 612, an OTP unit 613, and a RAM614. The secure IP 612 includes a decryption unit 6121 and an encryption unit 6122. The OTP unit 613 stores a key version 6131 and an encryption key 6132. The secure storage unit 63 stores the MAC value of the key ring (KEY #1 to KEY #n) and the key ring (KEY #1 to KEY #n).

In order to update the key ring (KEY #1 to KEY #n), the key setting unit 62 first requests SoC 61 to update the key version. When SoC 61 receives the update request, it transmits the key version to the secure IP 612 through CPU 611 (step S701). When the secure IP 612 receives the request for updating the key version, it updates the key version 6131 stored in the OTP unit 613 (step S702). The key version 6131 may be updated using, for example, a method of appending “1” to a table (“00000001” before updating, “00000011” after updating), or may be another method.

The update key ring (KEY #1 to KEY #n) is previously encrypted with the old key OKEY #1 to OKEY #n of each key, and the key setting unit 62 transmits the update key ring (KEY #1 to KEY #n) to SoC 61, and SoC 61 transmits the update key ring (KEY #1 to KEY #n) to the secure IP 612 through the CPU 611 (step S703). When the secure IP 612 receives the update key ring (KEY #1 to KEY #n), the decryption unit 6121 decrypts the key using the old key OOD #1 to OOD #n of each key, and the decrypted update key ring (KEY #1 to KEY #n) is encrypted by the key version 6131 that is updated at the time of requesting updating the key version stored in the OTP unit 613 by the encryption unit 6122 and the new encryption key 6133 that is generated from the encryption key 6132 (step S704).

The re-encrypted key ring (KEY #1 to KEY #n) is stored in RAM 614 (step S705). Further, the re-encrypted key ring (KEY #1 to KEY #n) is stored by overwriting the secure storage unit 63 (step S706). The new cryptographic key 6133 may be a composite value of the key version 6131 and the cryptographic key 6132, or may be, but is not limited to, a hash value of the composite value. Also, the method of storing in the secure storage unit 63 is not limited to overwriting, and may be stored in another area where existing values are stored.

According to the second embodiment, even if the key stored in the external storage is replaced, it is not possible to decode correctly, so that the rollback can be detected as a result. As a method of updating one key in the first embodiment has been described, the updating method according to the second embodiment may be targeted at each key of a key ring rather than a set of key ring.

According to the second embodiment, the rollback can be detected even if the external storage itself is replaced with a legitimate old key. In addition, since the key ring is version-managed by one table, the cost reduction of OTP can be attempted.

### Third Embodiment

In the first embodiment, a method of updating a single key and a method of updating a set of key ring in the second embodiment are described, but in a third embodiment, a method of centrally managing a table area for managing a firmware (FW) version stored in an existing OTP in combination with key version management is described in connection with an FW version and a key version.

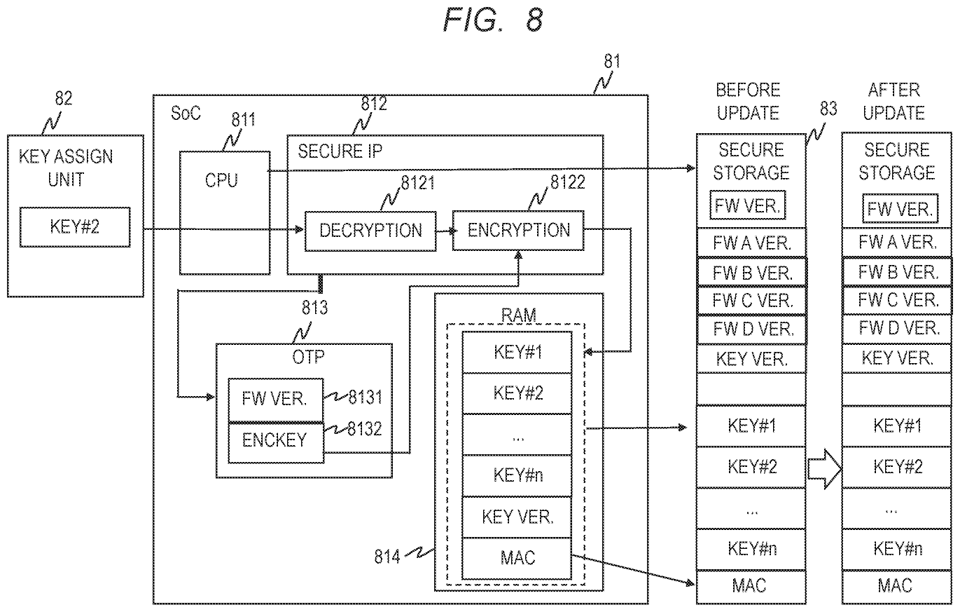

FIG. 8 is a key update management system configuration diagram according to the third embodiment. The key update management system includes a SoC 81, a key setting unit 82, and a secure storage unit 83. The SoC 81 includes a CPU 811, a secure IP 812, an OTP unit 813, and a RAM 814. The secure IP 812 includes a decryption unit 8121 and an encryption unit 8122. The OTP unit 813 stores the FW version 8131 and the encryption key 8132 associated with each FW version (FW version A to FW version D).

The secure storage unit 83 stores the MAC values of the secure boot certificate and the key ring (KEY #1 to KEY #n) and the key ring (KEY #1 to KEY #n). The secure boot certificate stores the key version of each FW (FW version A to FW version D), the key version of the key ring (KEY #1 to KEY #n), the version of each FW (FW version A to FW version D), and the FW version associated with the key version of the key ring (KEY #1 to KEY #n). A certificate is, for example, an ITU-T (International Telecommunication Union Telecommunication Standardization Sector public key infrastructure (PKI) standard.

In order to update the key KEY #2, the key setting unit 82 first requests SoC 81 to update the key version. When SoC 81 receives the update request, it transmits the key version to the secure IP 812 through CPU 811 (step S901). The update key KEY #2 is previously encrypted with the old key OKEY #2, the key setting unit 82 transmits the update key KEY #2 to SoC 81, and when SoC 81 receives the update key KEY #2, it transmits it to the secure IP 812 through CPU 811 (step S902). When the secure IP 812 receives the key version update request and the update key KEY #2, the decryption unit 8121 decrypts the recovery key OKEY #2 (step S903), decrypts the update key KEY #2 using the decrypted recovery key OKEY #2 (step S904), and the decrypted update key KEY #2 is encrypted by the encryption key 8132 stored in the OTP unit 813 in the encryption unit 8122 and stored in RAM 814 (step S905). The secure IP 812 then refreshes the key version stored in RAM 814 (step S906). Further, the MAC value is calculated from the key version updated in the step S906 and the key ring (KEY #1 to KEY #n) stored in RAM 814, and stored in RAM 814 (step S907).

Further, the key ring (KEY #1 to KEY #n) and the MAC value calculated by the step S907 are stored by overwriting the secure storage unit 83 (step S908). The FW version 8131 stored in the OTP unit 813 (step S909) is updated. For updating FW version 8131, for example, a method of appending “1” to the table (before updating “00000001”, after updating “00000011”) may be used. Also other methods may be used for updating FW version 8131.

Finally, the SoC 81 renews the secure boot certificate stored in the secure storage unit 83 (step S910). By the updated secure boot certificate, the updated key version value stored in RAM 814 is updated. Also, each FW version 8131 stored in the OTP unit 813 and the secure storage unit 83 is updated. Also, the method of storing in the secure storage unit 83 is not limited to overwriting, and may be stored in another area where existing values are stored.

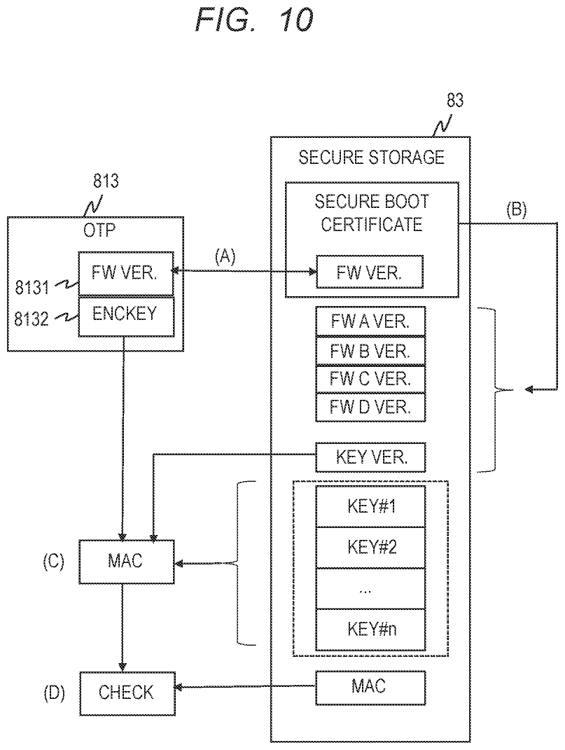

Next, a method of verifying the rollback of the key will be described with reference to FIG. 10. The rollback verification is performed at system startup,
(A) the version checking is performed by the certificate in which the secure IP 812 is stored in the secure storage unit 83 and the FW version 8131 stored in the OTP unit 813.
(B) The integrity of the FW versions A to D and the key versions is checked by the FW versions in which the secure IP 812 is stored in the secure storage unit 83.
(C) The secure IP 812 calculates the MAC value from the encryption key 8132 stored in the OTP unit 813 and the key version and the key ring whose integrity is checked by (B) stored in the secure storage unit 83.
(D) The secure IP 812 compares the MAC value calculated in (C) with the MAC stored in the secure storage unit 83. As a result of the comparison, the process continues if it matches, and if there is a mismatch, there is a failure that the key stored in the secure storage unit 83 is replaced, so security measures are required.

According to the third embodiment, it is possible to reduce the cost by sharing the OTP resources. More specifically, it is not necessary to create a new key version management table area in the OTP area, so the cost of implementing OTP can be reduced. In addition, version control on individual keys can be easily performed. The key version management table itself is realized by storing it in a non-volatile memory such as an external storage rather than an OTP area.

Although the invention made by the present inventor has been specifically described based on the embodiment, the present invention is not limited to the embodiment described above, and it is needless to say that various modifications can be made without departing from the gist thereof.

What is claimed is:

1. A key update management system comprising:
key update management unit for updating a version of an encryption key, and
a key storage unit for storing a key ring including a plurality of encrypted encryption keys and an authentication code,
wherein the key update management unit includes a processing unit for encrypting and decrypting the encryption key, a first memory for storing version information and a predetermined encryption key of the encryption key, and a second memory for storing a key ring including a plurality of encrypted encryption keys,
a first encryption key is stored in the key storage unit and the second memory,
when updating the first encryption key to the second encryption key encrypted by the first encryption key in advance, the key update management unit updates the version information of the encryption key stored in the first memory, decrypts the second encryption key encrypted by the first encryption key, generates a second encryption key by encrypting the decrypted encryption key by the predetermined encryption key, updates the encrypted first encryption key stored in the second memory to the second encryption key, calculates an authentication code from the version information of the updated encryption key and the key ring stored in the second memory, and stores the contents stored in the second memory in the key storage unit.

2. The key update management system according to claim 1, wherein at system startup, a rollback verification of the encryption key is performed by generating the authentication code from the key ring stored in the second memory and comparing the version information of the encryption key stored in the first memory with the authentication code stored in the key storage unit.

3. A key update management system comprising:
a key update management unit for updating a version of an encryption key and
a key storage unit for storing a key ring including a plurality of encrypted encryption keys,
wherein the key update management unit includes a processing unit for encrypting and decrypting by the encryption key, a first memory for storing version information and a predetermined encryption key of the encryption key, and a second memory for storing a key ring including a plurality of encrypted encryption keys,
the first key ring including a plurality of encryption keys encrypted with the first encryption key is stored in the key storage unit and the second memory,
when updating the first key ring to a second key ring including a plurality of encryption keys encrypted with the second encryption key, each of the plurality of encryption keys included in the first key ring is encrypted with the previous version of the encryption key,
wherein the key update management unit updates the version information of the encryption key stored in the first memory, generates a new version of the encryption key from the version information of the updated encryption key and the predetermined encryption key, decrypts a plurality of encryption keys encrypted by the encryption key of the previous version, generates a plurality of second encryption keys as a second key ring by encrypting the decrypted plurality of encrypted keys by the new version of the encryption key, updates the first key ring stored in the second memory to the second key ring, calculates an authentication code from the version information of the updated encryption key and the second key ring stored in the second memory, and stores the contents stored in the second memory in the key storage unit.

4. A key update management system comprising:
a key update management unit for updating a version of an encryption key and
a key storage unit for storing a key ring including a plurality of encrypted encryption keys and an authentication code,
wherein the key storage unit further stores firmware version information, version table and encryption key version information including the version information of the plurality of firmware,
the key update management unit includes a processing unit for encrypting and decrypting the encryption key, a first memory for storing the firmware version information and a predetermined encryption key, and a second memory for storing the version information of the key ring and the encryption key including a plurality of encrypted encryption keys,
the first encryption key is stored in the key storage unit and the second memory,
when updating the first encryption key to the second encryption key, the second encryption key in advance is encrypted by the first encryption key,
wherein the key update management unit updates the firmware version information stored in the first memory, decrypts the second encryption key encrypted by the first encryption key, generates a second encryption key by encrypting the decrypted second encrypted key by the predetermined encryption key, updates the encrypted first encryption key stored in the second memory to the second encryption key, updates the version of the encryption key stored in the second memory, calculates an authentication code from the version information of the updated key ring and the updated encryption key stored in the second memory, and stores the contents stored in the second memory in the key storage unit.

5. The key update management system according to claim 4, wherein at system startup, compares the firmware information stored in the key storage unit and the version information of the firmware stored in the first memory, verifies the version table and encryption key version information from the firmware version information,
wherein a rollback verification of an encryption key is performed by generating an authentication code from version information of a key ring and an encryption key stored in the key storage unit and comparing the authentication code with an authentication code stored in the key storage unit.

6. The key update management system according to claim 1, wherein the version information of the encryption key is a count value and counts up by 1 each time the version of the encryption key is updated.

7. The key update management system of claim 1,
wherein the first memory is an OTP (One Time Programmable).

8. The key update management system of claim 1,
wherein the authentication code is a MAC value.

9. A key update management method in a key update management system comprising a key update management unit for updating a version of an encryption key and a key storage unit for storing a key ring including a plurality of encrypted encryption keys and an authentication code,
the key update management unit includes a processing unit for encrypting and decrypting the encryption key, a first memory for storing version information and a predetermined encryption key of the encryption key, and a second memory for storing a key ring including a plurality of encrypted encryption keys,
the first encryption key is stored in the key storage unit and the second memory,
when updating the first encryption key to the second encryption key, the second encryption key in advance is encrypted by the first encryption key,
the key update management method by the key update management unit comprising:
updates the version information of the encryption key stored in the first memory,
decrypts the second encryption key encrypted by the first encryption key,
generates the second encryption key that is re-encrypted encrypted by encrypting the second encrypted key decrypted by the predetermined encryption key,
updates the encrypted first encryption key stored in the second memory to the second encryption key re-encrypted, calculates an authentication code the version information of the updated encryption key, and from the key ring stored in the second memory, and
stores the contents stored in the second memory in the key storage unit.

10. A key update management method in a key update management system comprising a key update management unit for updating a version of an encryption key and a key storage unit for storing a key ring including a plurality of encrypted encryption keys,
wherein the key update management unit includes a processing unit for encrypting and decrypting the encryption key, a first memory for storing version information and a predetermined encryption key of the encryption key, and a second memory for storing a key ring including a plurality of encrypted encryption keys,
the first key ring including a plurality of encryption keys encrypted with the first encryption key is stored in the key storage unit and the second memory,
when updating the first key ring to a second key ring including a plurality of encryption keys encrypted with the second encryption key, each of the plurality of encryption keys included in the first key ring is encrypted with the previous version of the encryption key,
the key update management method by the key update management unit comprising:
updates the version information of the encryption key stored in the first memory,
generates a new version of the cryptographic key from the version information of the updated cryptographic key and the predetermined cryptographic key,
decrypts a plurality of encryption keys encrypted by the encryption key of the previous version,
generates a plurality of second encryption keys as a second key ring by encrypting decrypted plurality of encrypted keys by the new version of the encryption key,
updates the first key ring stored in the second memory to the second key ring,
calculates an authentication code from the version information of the updated encryption key and the second key ring stored in the second memory, and
stores the contents in the second memory in the key storage unit.

11. A key update management method in a key update management system comprising a key update management unit for updating a version of an encryption key and a key storage unit for storing a key ring including a plurality of encrypted encryption keys and an authentication code,
the key storage unit further stores firmware version information, version table and encryption key version information including the version information of the plurality of firmware,
the key update management unit includes a processing unit for encrypting and decrypting the encryption key, a first memory for storing the firmware version information and a predetermined encryption key, and a second memory for storing the version information of the key ring and the encryption key including a plurality of encrypted encryption keys,
the first encryption key is stored in the key storage unit and the second memory,
when updating the first encryption key to the second encryption key, the second encryption key in advance is encrypted by the first encryption key,
the key update management method by the key update management unit comprising:
updates the firmware version information stored in the first memory,
decrypts the second encryption key encrypted by the first encryption key,
generates the second encryption key by encrypting the decrypted second encryption key by the predetermined encryption key,
updates the encrypted first encryption key stored in the second memory to the re-encrypted second encryption key,
updates the version of the encryption key stored in the second memory,
calculates an authentication code from the version information of the key ring and the updated encryption key stored in the second memory, and
stores the contents in the second memory in the key storage unit.
